(19) United States
(12) Patent Application Publication
(10) Pub. No.: US 2010/0178451 A1
(43) Pub. Date: Jul. 15, 2010

(54) METHOD FOR PRODUCING BAMBOO BOARDS AND PRODUCTS

(75) Inventor: Jian Hua Li, Anji County (CN)

Correspondence Address: KNOBBE MARTENS OLSON & BEAR LLP, 2040 MAIN STREET, FOURTEENTH FLOOR, IRVINE, CA, 92614, US

(73) Assignee: Style Limited, Melbourne (AU)

(21) Appl. No.: 12/687,785

(22) Filed: Jan. 14, 2010

Related U.S. Application Data
(60) Provisional application No. 61/145,016, filed on Jan. 15, 2009.

(51) Int. Cl. B32B 21/13; B27J 7/00

(52) U.S. Cl. 428/106; 144/333

(57) ABSTRACT

Manufactured bamboo products and methods of making thereof are disclosed herein. The method may include providing a plurality of elongated bamboo strips, separating each elongated bamboo strip along its length into a plurality of bamboo lengthwise segments that remain attached, applying glue to each separated bamboo strip, loading the separated bamboo strips into a mold, and applying pressure to the separated bamboo strips in the mold to produce a manufactured bamboo product.

### CROSS-REFERENCE TO RELATED APPLICATIONS

This application claims the benefit and priority of U.S. Application Ser. No. 61/145,016, filed Jan. 15, 2009, currently pending, which is hereby incorporated by reference in its entirety.

### BACKGROUND

Disclosed herein are manufactured bamboo products and methods of making thereof. More particularly, the manufactured bamboo products described herein may include bamboo boards and others wherein the grain of the product is displayed, as in bamboo flooring.

In the face of growing environmental concerns such as deforestation, many industries have sought alternatives to wood for products such as wood flooring. For example, one such alternative to wood flooring, and other wood-containing products, is bamboo. Unlike traditional woods, bamboo is a grass, and is one of the fastest-growing plants in the world. Bamboo can mature for harvest in approximately three to five years, as opposed to over one hundred years for some types of wood. Because it is a grass, bamboo may automatically regenerate from the base of the plant, reducing or eliminating the need for seasonal replanting. Consequently, the cultivation of bamboo may result in reduced soil erosion or runoff. Cultivation of bamboo also may require little to no fertilizer. While wood production may result in a large amount of generally unusable scrap material, the manufactured bamboo production process may generate significantly less waste. Furthermore, material not used in the manufactured bamboo process, such as shoots and/or leaves, may be used for a variety of secondary purposes such as mats, fuel, and livestock feed. It has been estimated that once harvested, as little as 5% of the raw bamboo material eventually ends up as waste.

Bamboo may be an attractive wood alternative in part because finished bamboo product can look very similar to real wood. The manufacturing process may result in a bamboo beam, for example, that has a grain appearance similar to wood. Furthermore, bamboo products have the added benefit of having hardness, density, and durability that is comparable to natural wood, and in some cases may be superior to wood. These aesthetic and structural properties of bamboo further suggest that bamboo may be particularly appropriate for use instead of wood to create boards, panels, beams, veneer, etc, for eventual use in flooring, furniture, siding, and the like. Altogether, the many benefits of bamboo have served to increase interest in its use as a substitute for many wood products.

Various methods of making manufactured bamboo products are known to those of ordinary skill in the art. Some methods may produce manufactured bamboo products that can be harder and denser than traditional bamboo, which would be of particular interest as an alternative to wood flooring or other wood products. In some methods, bamboo culms are cut into pieces which may be glued together and layered to create a surface. In other methods, segments of bamboo culms may be separated into bamboo strips that are glued together and layered. Heat and/or pressure may then be applied to form a bamboo beam. An example of a method for making manufactured bamboo products is disclosed in Chinese Patent No. 99117809.2 to Anji Tianfeng Timber Co., Ltd., wherein bamboo is broken into strips, dried, impregnated with glue, placed into molds, and pressed.

Despite the promise of bamboo as a wood alternative, several difficulties have been encountered in the manufactured bamboo production process. Manufactured bamboo products are often made from raw material such as bamboo strips or slats. Where bamboo strips are used as the raw material, the outer surface of the manufactured bamboo product may be sensitive to deformity due to water absorption. This effect may be due to the difference in density between the inside and outside of the bamboo fiber, wherein higher pressure results in more pronounced deformation upon absorption of water. Deformation may lead to warping, cupping, expansion, and/or cracking of the finished bamboo product, adversely affecting its visual appearance as well as its structural integrity.

In some instances, bamboo fibers separated into threads may be used. These bamboo threads may be mechanically prepared. A mechanical process may be preferred over a chemical process, which may include risks such as water supply contamination or other environmental concerns. The use of bamboo threads, however, may have adverse effects on the final product. Where fine, soft threads are used, the mechanical strength, hardness, and/or durability of the bamboo may be compromised. In addition, subsequent steps of impregnating the fine bamboo threads with glue and arranging them in a mold may prove difficult. The bamboo threads may also be approximately rod-shaped, of varying thicknesses. This shape may result in a distorted grain on the outer surface of the finished product.

### SUMMARY

As explained above, a need exists for a manufactured bamboo product that has increased resistance to deformity, generates relatively little water contamination, maintains the strength of the bamboo, is easy and simple to produce, and has a relatively uniform grain.

Some embodiments disclosed herein are directed to a method of preparing bamboo for use in a manufactured bamboo product, which can include providing a plurality of elongated bamboo strips, and separating each elongated bamboo strip along its length into a plurality of bamboo lengthwise segments that remain attached.

Some embodiments disclosed herein are directed to a method of preparing bamboo for use in a manufactured bamboo product, which can include providing a plurality of elongated bamboo strips, and separating each elongated bamboo strip along its length into a plurality of bamboo lengthwise segment comprising a plurality of continuously-connected longitudinal raised-notch staggered bands.

Some embodiments disclosed herein are directed to a method of making a manufactured bamboo product, which can include providing a plurality of elongated bamboo strips, separating each elongated strip along its length into a plurality of bamboo lengthwise segments that remain attached, applying glue to each separated bamboo strip, loading the separated bamboo strips into a mold, and applying pressure to the separated bamboo strips in the mold to produce a manufactured bamboo product.

In some embodiments, each separated bamboo strip may include a plurality of continuously-connected bands. In other embodiments, each separated bamboo strip may include a plurality of continuously-connected longitudinal raised-notch staggered bands.

In some embodiments, the manufactured bamboo product may include a bamboo board. In other embodiments, the manufactured bamboo product may include bamboo flooring.

In some embodiments, each separated bamboo strip may be carbonized prior to the application of glue. In some embodiments, the glue may include phenol, formaldehyde, water, and sodium hydroxide. The glue may be applied by dip-coating. In some embodiments, each separated bamboo strip may be at least partially dried after the application of glue and before the loading of the sheets into the mold.

In some embodiments, the plurality of bamboo strips may be made by a process which includes providing a section of a bamboo culm with one or more interior or exterior nodes, where this section has a length of at least 1000 mm along the natural grain thereof, removing the one or more interior or exterior nodes, and cutting the bamboo section generally lengthwise along the grain thereof into a plurality of bamboo strips. In some embodiments, the plurality of bamboo strips may include one or more of an exterior green surface and an innermost surface of a bamboo culm.

In some embodiments, at least some sugar may be removed from the plurality of bamboo strips. In some embodiments, the plurality of bamboo strips may be dried to a final water content of about 5 wt % to about 15 wt %.

In some embodiments, the separated bamboo strips may be heated in the mold to a temperature of about 75° C. to about 175° C.

In some embodiments, the bamboo strips may be removed from the mold to yield a bamboo block, at least a portion of an outer layer of the bamboo block may be removed, the bamboo block may be allowed to sit at substantially ambient temperature, the bamboo block may be cut into boards, and the bamboo boards may be at least partially dried.

These and other embodiments are described in greater detail below.

### BRIEF DESCRIPTION OF THE DRAWINGS

The illustrated embodiments are intended to illustrate, but are not intended to be limiting. The drawings contain the following figures:

FIG. 1 is a process chart illustrating a series of steps for one embodiment disclosed herein.

FIG. 2 illustrates a diagram of a bamboo culm, including a cross section of a portion of the culm.

FIG. 3 is a schematic of one embodiment for cutting a bamboo section into strips, and separating the strips.

FIG. 4 illustrates one embodiment of a rolling machine capable of rolling the bamboo strips described herein.

FIG. 5 illustrates a perspective view of the upper and lower ridged rollers of one embodiment of the rolling machine shown in FIG. 4.

FIG. 6 illustrates a side view of the upper and lower ridged rollers of one embodiment of the rolling machine shown in FIG. 4.

FIG. 7 is an enlarged view of FIG. 5.

FIG. 8A is an elevated view of a separated bamboo strip depicting the longitudinal raised-notch staggered bands, continuously-connected via bamboo threads.

FIG. 8B is a side view of the separated bamboo strip depicted in FIG. 8A.

### DETAILED DESCRIPTION

The following discussion describes in detail several embodiments of manufactured bamboo products and methods of making thereof, as well as various other aspects of these embodiments. This discussion should not be construed, however, as limiting the present inventions to those particular embodiments. Practitioners skilled in the art will recognize numerous other embodiments including those that can be made through various combinations of the aspects of the illustrated embodiments.

As used herein, the term “manufactured bamboo product” is used in its ordinary sense and includes any type of man-made or machine-made bamboo item, including but not limited to bamboo composite material, laminated bamboo flooring, bamboo veneer, strand woven bamboo, and strand woven composite bamboo. A manufactured bamboo product may include any part of a bamboo plant, including but not limited to the culm.

Turning now to the drawings provided herein, a more detailed description of the embodiments described herein is provided below.

### Preparation of the Raw Bamboo Material

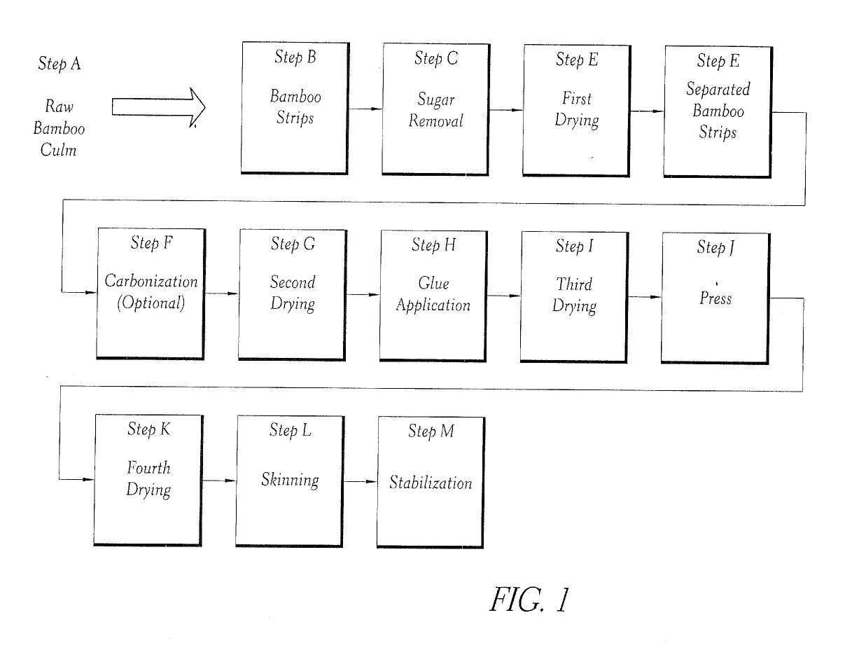

FIG. 1 shows a process chart illustrating a series of steps for one embodiment of a method of making a manufactured bamboo product. Those of ordinary skill in the art may appreciate that not all steps may be used in some embodiments. Those of ordinary skill in the art may also appreciate that in some embodiments, the steps may be performed in an order different from that shown in FIG. 1.

As shown in Step A of FIG. 1, raw bamboo culms are gathered. Many varieties of bamboo may be used, including moso bamboo (Phyllostachys pubescens). The culms may be harvested at maturity, which may be about 3 years to about 6 years old. The culms may be of a variety of diameters and lengths. These dimensions may vary according to several factors, including but not limited to age, climate, and geography. In some embodiments, the harvested bamboo may be from about 3 m to about 5 m in length and/or about 2 inches to about 8 inches in diameter. The raw bamboo culms are advantageously screened to eliminate culms with discoloration, irregularities, and/or mold.

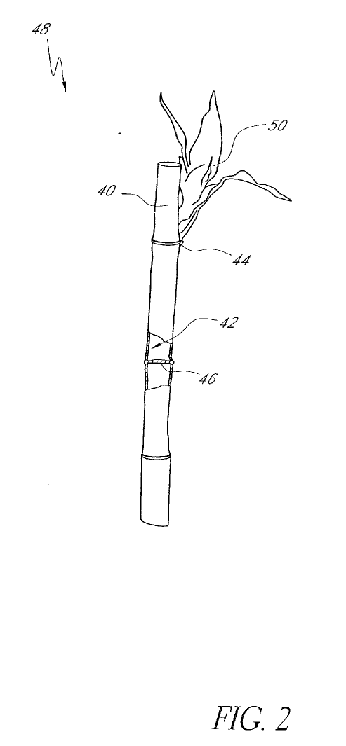

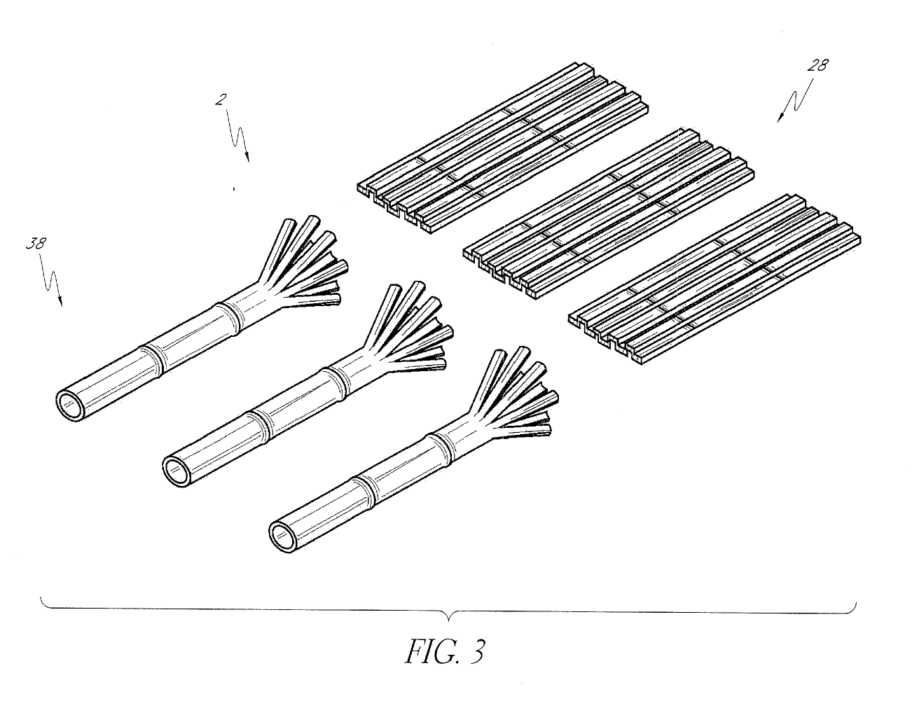

As shown in Step B of FIG. 1 and in FIG. 3, the bamboo culms are advantageously cut into elongated bamboo strips 2. The bamboo culms may first be cut into sections 48, as shown in FIG. 2. In some embodiments, these sections 48 may be from approximately 1000 mm to approximately 3000 mm in length. In other embodiments, each bamboo section 48 may be approximately 1500 mm to approximately 2500 mm in length. In some embodiments, at least a portion of the nodes 44 may be removed. In some embodiments, this may be done to create a substantially smooth surface on the exterior of the bamboo section 48. Any bumps, branches, leaves 50, or other discontinuities may also be removed from each bamboo section 48. This would include, in some instances, also removing the membranes 46 along the interior portion of the bamboo section 48. In other embodiments, the membranes 46 may be removed after the bamboo sections have been further processed. For example, the membranes 46 may be removed after the bamboo sections 48 have been sliced to expose the inner portion.

Each bamboo culm may have an outer green layer 40 and innermost layer 42, as shown in FIG. 2. In some embodiments, the outer green layer 40 and the innermost layer 42 of the bamboo culm are removed. In other embodiments, the outer green layer 40 and the innermost layer 42 may remain on the bamboo section and may be present in the final manufactured bamboo product. Advantageously, the use of the outer green layer 40 and the innermost layer 42 may result in less waste and increased efficiency.

The resulting bamboo sections 38, either with or without the outer and innermost layers removed, are then cut into elongated bamboo strips 2, as shown in FIG. 3. The elongated bamboo strips 2 may be cut longitudinally along the grain of each bamboo section 38. Each elongated bamboo strip 2 may have a width and a thickness. In some embodiments, each strip 2 may have a width of about 5 mm to about 50 mm. In other embodiments, each strip 2 may have a width of about 10 mm to about 30 mm. Each strip 2 may also have a thickness of about 2 mm to about 5 mm. In other embodiments, each strip 2 may have a thickness of about 3 mm to about 4 mm. Those of ordinary skill in the art will appreciate that other dimensions of the elongated bamboo strip 2 may be utilized with the methods disclosed herein.

The cutting of bamboo culms into sections, removal of outer green layer, innermost layer, nodes, and membranes, and/or cutting of bamboo sections into strips may be accomplished by a variety of methods as may be known to those of ordinary skill in the art. In some embodiments, these methods may vary depending on many factors including, but not limited to, location, sophistication of the work force, and level of technological development of the country in which the work is being done. For example, these processes may be accomplished by hand using a slicing tool such as a knife or machete. In another example, the bamboo culm may be cut into sections using a machine such as a circular saw or a peeling-type machine. In yet another example, the removal of the outer green layer may be accomplished using a sectioning cutter. In some embodiments, a machine with a series of knives similar to a large two-handled vegetable peeler may be used.

Compared to wood, bamboo may have a higher sugar content, which can lead to insect infestation or premature degradation in the finished manufactured bamboo product. As shown in FIG. 1, in Step C the elongated bamboo strips 2 may be treated to remove at least some amount of the sugars present. Various methods of sugar removal may be used, including but not limited to, steaming, pressure steaming, and boiling. In addition to removing sugars, these and other processes may be used to remove insects, mold, mildew, or other impurities in the bamboo. In any of these methods, additional chemicals such as antiseptics or acids, such as boric acid and hydrogen peroxide, may also be utilized to facilitate removal of insects, mold, and mildew, for example. In some embodiments, a solution including water and/or hydrogen peroxide may be used in conjunction with these methods. In some embodiments, the elongated bamboo strips 2 may be subject to steaming, pressure steaming, and/or boiling for about 10 minutes to about 5 hours. In other embodiments, the elongated bamboo strips 2 may be subject to steaming, pressure steaming, and/or boiling for about 15 minutes to about 4 hours. Those of ordinary skill in the art will appreciate that various other methods for removal of sugar and/or other impurities may be used to treat the elongated bamboo strips 2 described herein.

The elongated bamboo strips 2 are then dried, as in Step D of FIG. 1. In some embodiments, the elongated bamboo strips 2 may be air-dried at room temperature. In other embodiments, the elongated bamboo strips 2 may be dried using heat, as in an oven. In still other embodiments, the elongated bamboo strips 2 may be dried outdoors, e.g., in the sun. Those of ordinary skill in the art may appreciate that the temperature and duration of drying may vary according to factors including but not limited to ambient humidity, ambient temperature, and natural variation in the raw bamboo material. In some embodiments, the elongated bamboo strips 2 may be dried to an extent that the resulting moisture content is from about 5 wt % to about 15 wt %. In other embodiments, the elongated bamboo strips 2 may be dried to an extent that the resulting moisture content is from about 6 wt % to about 12 wt %.

Rolling the Raw Bamboo Material

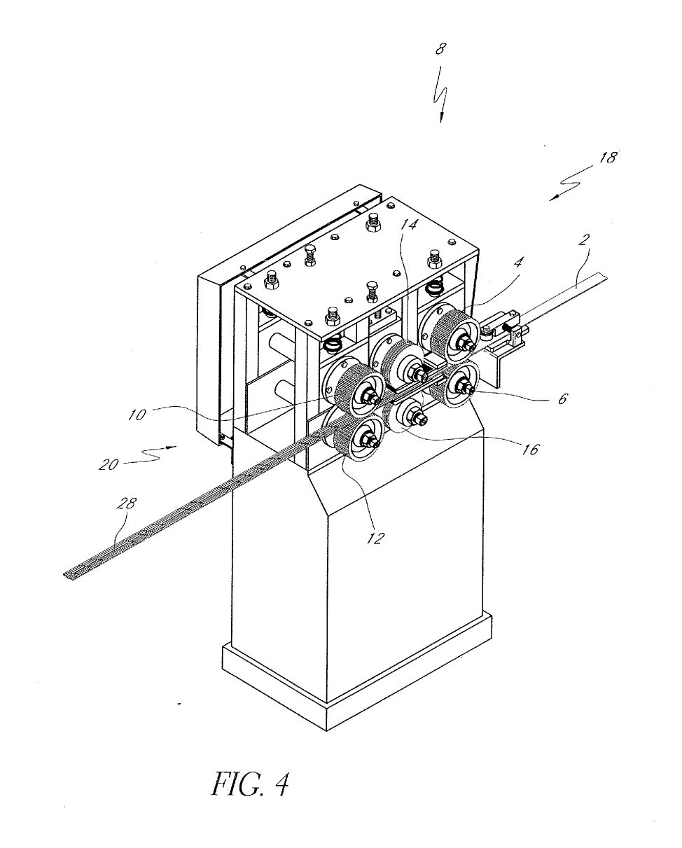

As shown in FIG. 1, in Step E the elongated bamboo strips 2 may be rolled to produce separated bamboo strips 28. These separated bamboo strips 28 may also be referred to as bamboo sheets. In the rolling process, each elongated bamboo strip 2 may be separated along its length into a plurality of bamboo lengthwise segments that remain attached. Those of ordinary skill in the art will appreciate that various apparatuses may be used to roll the elongated bamboo strips 2 in the method described herein. An example of a rolling machine 8 that may be used is shown in FIG. 4. As shown in FIG. 4, the elongated bamboo strip 2 can be fed from the input side 18 of the rolling machine 8, and through a first pair of upper and lower conveyor rollers 4, 6. The first pair of upper and lower conveyor rollers 4, 6 may be oriented directly one atop the other, as shown in FIG. 4. The first pair of upper and lower conveyor rollers 4, 6 may have teeth or another increased-friction surface to grip the elongated bamboo strip 2 and convey it along the rolling machine 8 to a pair of upper and lower ridged rollers 14, 16.

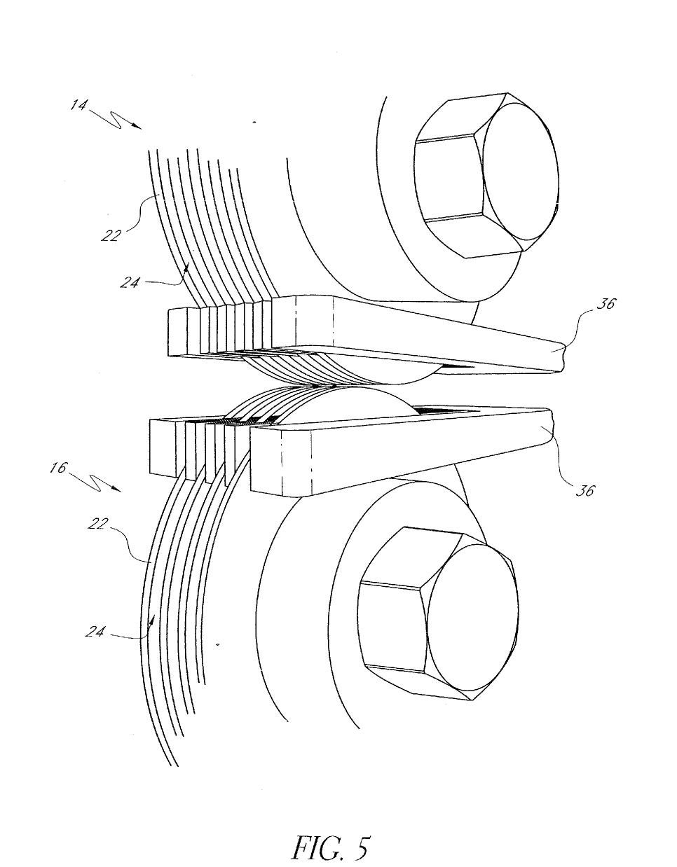

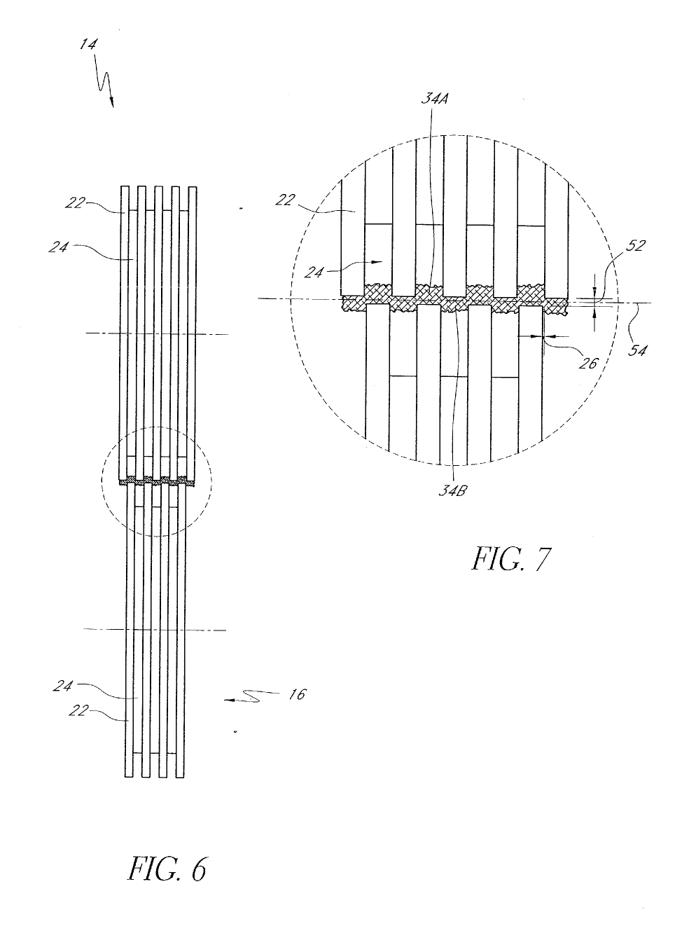

The upper and lower ridged rollers 14, 16 may each have a guide 36, as shown in FIG. 5. The guides 36 may be horizontally parallel to one another and may help facilitate passage of the elongated bamboo strip 2 between the upper and lower ridged rollers 14, 16. The upper and lower ridged rollers 14, 16 may be of various diameters. In some embodiments, each of the upper and lower ridged rollers 14, 16 may be from about 5 cm to about 15 cm in diameter. In other embodiments, each of the upper and lower ridged rollers 14, 16 may be from about 10 cm to about 15 cm in diameter. The surfaces of upper and lower ridged rollers 14, 16 are shown in FIGS. 5-7. Each of upper and lower ridged rollers 14, 16 have a series of ridges 22 and grooves 24 traversing the outer circumference. As shown in FIGS. 6-7, ridges 22 and grooves 24 may be alternatively arranged. In addition, the ridges 22 of the upper roller 14 and the grooves 24 on the lower roller 16 may be staggered, as shown in FIGS. 6-7. Any number of ridges 22 and grooves 24 may be used on the upper and lower ridged rollers 14, 16. In some embodiments, each upper and lower ridged roller 14, 16 may have about five to about ten ridges 22. The upper and lower ridged rollers 14, 16 may each have different numbers of ridges 22 and/or grooves 24, as shown in FIGS. 6-7. In some embodiments, the width of each ridge 22 and/or groove 24 may be from about 1 mm to about 5 mm. In other embodiments, the width of each ridge 22 and/or groove 24 may be from about 2 mm to about 4 mm. In some embodiments, the width of each ridge 22 and/or groove 24 may be adjusted as desired. As shown in FIG. 7, the width of the groove 24 may be wider than the width of the ridge 22, resulting in a horizontal gap 26. In some embodiments, the horizontal gap 26 may be approximately 0.1 mm to approximately 0.8 mm wide. In other embodiments, the horizontal gap 26 may be approximately 0.2 mm to approximately 0.5 mm wide. In still other embodiments, the width of the ridge 22 may be greater than the width of the groove 24 (not shown).

As shown in FIG. 7, there may be a horizontal plane 54 between the upper and lower ridged rollers 14, 16. In some embodiments, the length of each ridge may stop short of the horizontal plane, resulting in a vertical gap 52. In some embodiments, the distance of the vertical gap 52 may be from about 1 mm to about 5 mm. In other embodiments, the distance of the vertical gap 52 may be from about 1 mm to about 3 mm. In other embodiments, each ridge 22 may have a length such that the ridge 22 lies flush against the horizontal plane (not shown). In still other embodiments, the length of each ridge 22 may be such that the ridge transcends the horizontal plane 54 (not shown). Those of ordinary skill in the art may appreciate that the distance between the upper and lower ridged rollers 14, 16 may increase or decrease as desired.

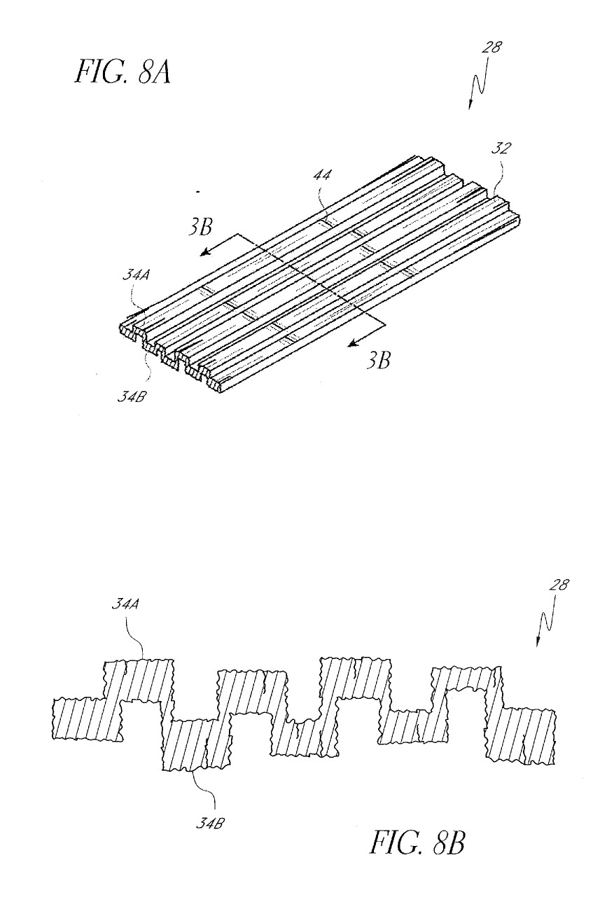

The upper and lower ridged rollers 14, 16 may apply pressure to the elongated bamboo strip 2 as it passes between them, creating a separated bamboo strip 28. In some embodiments, each bamboo strip 2 may be separated along its length into a plurality of bamboo lengthwise segments that remain attached. In some embodiments, the width of the resulting separated bamboo strip 28 is approximately the same as the width of the elongated bamboo strip 2. The pressure of the upper and lower ridged rollers 14, 16 may result in at least partial separation of the elongated bamboo strip 2 into bamboo threads, as well as the formation of one or more longitudinal raised-notch staggered bands 34A-B on the separated bamboo strip 28, as shown in FIG. 7-8B. The term “bamboo thread” as used herein refers to thin, fibrous pieces of bamboo. The fibrous characteristic of bamboo thread may be due to the cellulose, lignin, and/or hemicellulose content of the bamboo. Each band 34A-B on the separated bamboo strip 28 corresponds to an impression made by the upper and lower ridged rollers 14, 16, and may particularly correspond to the interface between a ridge 22 on an upper ridged roller 14 and a groove 24 on a lower ridged roller 16, or vice versa. As shown in FIG. 7-8B, the upper bands 34A may be vertically staggered between the lower bands 34B, as opposed to being vertically aligned. The separated bamboo strip 28 may have a plurality of longitudinal raised-notch staggered bands 34A-B, as shown in FIG. 7-8B. In some embodiments, the separated bamboo strip 28 may have about five to about ten longitudinal raised-notch staggered bands 34A-B. The width of each longitudinal raised-notch staggered band 34A-B may be about 1 mm to about 5 mm. In an embodiment, the width of each longitudinal raised-notch staggered band 34A-B may be about 1.5 mm to about 4 mm. Advantageously, variations in the width of each longitudinal raised-notch staggered band 34A-B may affect the appearance and/or quality of the manufactured bamboo product. Although not to be bound by theory, it is believed that the pattern of longitudinal raised-notch staggered bands may allow for closer packing of separated bamboo strips 28 into a mold. For example, the longitudinal raised-notch staggered bands of a first separated bamboo strip 28 may interlock with the longitudinal raised-notch staggered bands of a second separated bamboo strip 28. This may result in a tight fit with relatively few gaps, thus enhancing the strength of the manufactured bamboo product.

As shown in FIGS. 7-8B, the horizontal gap 26 may generate an incomplete shear, producing a separated bamboo strip 28 with continuously-connected longitudinal raised-notch staggered bands 34A-B, as opposed to completely cutting the elongated bamboo strip 2 into separate, discrete pieces. The term “continuously connected” as used herein refers to a connection wherein each band 34A-B may be connected at least in part within each band, as well as to an immediately adjacent band, thus resulting in a separated bamboo strip 28, as shown in FIG. 8A. The longitudinal raised-notch staggered bands 34A-B may be continuously connected by adjacent bamboo threads 32, as shown in FIGS. 8A.

Advantageously, the incomplete shear generated by the horizontal gap 26 may also ensure that the separated bamboo strip 28 maintains approximately the shape of the elongated bamboo strip 2. The maintenance of shape as well as the continuous connection may also be facilitated by the bamboo nodes 44, as shown in FIG. 8A. The nodes 44 may be less prone to separation into threads as compared with other portions of the elongated bamboo strip 2. In addition, the continuously-connected nature of the separated bamboo strip 28 may further ensure that a similar, uniform structure is maintained throughout the entire separated bamboo strip 28. This uniformity may enhance the structural integrity and aesthetic value of the separated bamboo strip 28 and the resulting manufactured bamboo product. Furthermore, the continuously-connected nature of the separated bamboo strip 28 may facilitate subsequent steps such as applying glue, loading, and pressing of the sheet 28.

After passing between upper and lower ridged rollers 14, 16, the separated bamboo strip 28 may continue through a second pair of upper and lower conveyor rollers 10, 12, as shown in FIG. 1. Similar to the first pair 4, 6, the second pair of upper and lower conveyor rollers 10, 12 may have teeth or another increased-friction surface to facilitate discharging the separated bamboo strip 28 out of the rolling machine 8 at the output side 20, as shown in FIG. 4.

### Process After the Rolling Step

As shown in Step F of FIG. 1, the separated bamboo strips 28 may optionally be subject to carbonization via heating, for example, by steaming, pressure steaming, boiling, or in an oven, for the purpose of changing the color of the bamboo. Although not to be limited by theory, it is believed that when the sugar in the bamboo is exposed to heat, the sugar may give the bamboo a darker brown finish. Advantageously, this process may contribute to a manufactured bamboo product that has the appearance of a darker hardwood. As shown in FIG. 1, the carbonization process may take place after the production of separated bamboo strips 28. In some embodiments, the carbonization process may take place at a different point in the process, such as either before or after the sugar removal step.

As shown in FIG. 1, in Step G the separated bamboo strips 28 may be dried. In some embodiments, the separated bamboo strips 28 may be air-dried at room temperature. In other embodiments, the separated bamboo strips 28 may be dried using heat, as in an oven. In still other embodiments, the separated bamboo strips 28 may be dried outdoors, e.g., in the sun. Those of ordinary skill in the art may appreciate that the temperature and duration of drying may vary according to factors including but not limited to ambient humidity, ambient temperature, and natural variation in the raw bamboo material. In some embodiments, the separated bamboo strips 28 may be dried to an extent that the resulting moisture content is from about 5 wt % to about 15 wt %. In other embodiments, the separated bamboo strips 28 may be dried to an extent that the resulting moisture content is from about 6 wt % to about 12 wt %.

In Step H as shown in FIG. 1, glue may be applied to the separated bamboo strips 28. As may be appreciated by those of ordinary skill in the art, a variety of different glues may be used in the methods described herein. A particular type of glue may be chosen for its particular properties, for example, water-resistance. These glues may include, for example, phenol-formaldehyde, urea-formaldehyde, or a non-formaldehyde glue. The glue may be adapted to reduce the amount of gas emission. In an embodiment, the glue may be adapted to reduce the emission of volatile organic compounds (VOCs) such as formaldehyde. In some embodiments, the glue may include phenol, formaldehyde, water, and sodium hydroxide. In some embodiments, water may be added to a phenol-formaldehyde glue to yield a particular viscosity. The amount of water added may vary depending on the density of the glue. In some embodiments, equilibrium may be sought between the density of the separated bamboo strips 28 and the glue. In other words, the glue may be diluted with an amount of water that is needed for the glue to have a density approximately equal to the density of the bamboo strips 28. Those of ordinary skill in the art may appreciate that as density increases, the viscosity of the glue may also increase. In some embodiments, the glue may be diluted with water in a 1:1 ratio. In some embodiments, the amount of glue used with the separated bamboo strips 28 may be from about 5 wt % to about 20 wt % of the total weight of the glue and separated bamboo strips 28. In other embodiments, the amount of glue used may be from about 6 wt % to about 15 wt % of the total weight of the glue and separated bamboo strips 28. In still other embodiments, the amount of glue used may be from about 8 wt % to about 15 wt % of the total weight of the glue and separated bamboo strips 28. The glue may be applied to the separated bamboo strips 28 by a variety of methods available to those of ordinary skill in the art, including but not limited to, by hand, brush, spray, roller, machine, and/or curtain coater. In an embodiment, each separated bamboo strip 28 may be dip-coated in glue. In some embodiments, each separated bamboo strip 28 may be substantially completely coated with glue. In other embodiments, each separated bamboo strip 28 may be partially coated with glue. Each separated bamboo strip 28 may be coated with glue substantially on its exterior surface. In other embodiments, each separated bamboo strip 28 may be at least partially impregnated with glue, wherein the glue may be absorbed beneath the exterior of the sheet 28.

Although not to be bound by theory, it is believed that the rolling step as described herein may result in the breaking of the internal structure of the elongated bamboo strip 2, causing damage to the capillaries and cells. It is believed that the broken capillaries and cells, which may otherwise hold water and/or sugar, may take in glue more readily than capillaries and cells that are still in tact. This increased absorption of glue by the separated bamboo strip 28 may result in a relatively stronger manufactured bamboo product.

After the glue is applied, the separated bamboo strips 28 may be dried in a third drying step, as shown in Step I of FIG. 1. The separated bamboo strips 28 may be dried at various temperatures and for various times, as may be appreciated by those of ordinary skill in the art. Factors affecting a chosen temperature and/or time may include, but are not limited to, ambient temperature, ambient humidity, and location. In some embodiments, the separated bamboo strips 28 may be left outdoors, e.g., under the sun, to air-dry. In an embodiment, the separated bamboo strips 28 may be drip-dried to remove excess glue. In some embodiments, the separated bamboo strips 28 may be dried until the glue is not wet to the touch.

After the glue has dried, the separated bamboo strips 28 may be loaded into a mold and pressed, as shown in Step J of FIG. 1. Molds of various shapes and dimensions may be used as desired for the final manufactured bamboo product. In some embodiments, the mold may be approximately rectangular, with a length at least as long as the separated bamboo strips 28. In an embodiment, the length of the mold may be greater than the width of the mold. Those of ordinary skill in the art may appreciate that various other mold shapes may be used, including but not limited to a square mold and a panel mold. In some embodiments, the mold may have a length from about 900 mm to about 1850 mm. In other embodiments, the mold may have a length from about 900 mm to about 4250 mm. The separated bamboo strips 28 may be weighed before being loaded into the mold. In some embodiments, each mold of substantially the same size may be loaded with an approximately equal weight of separated bamboo strips 28. For example, each mold may be loaded with about 25 kg to about 35 kg of separated bamboo strips 28. In an embodiment, each mold may be loaded with about 30 kg to about 35 kg of separated bamboo strips 28. The separated bamboo strips 28 may be loaded approximately parallel lengthwise to each other, but in an otherwise random orientation. In other embodiments, the separated bamboo strips 28 may be loaded in an organized, stacked configuration. The separated bamboo strips 28 may be loaded to a height below the top of the mold. In other embodiments, the separated bamboo strips 28 may be loaded to a height above, or approximately equal to, the top of the mold. In some embodiments, about 10 MPa to about 100 MPa of pressure may be applied to the separated bamboo strips 28 in the mold via a press. In other embodiments, the amount of pressure used may be about 50 MPa to about 100 MPa. Pressure may be applied by a variety of means as may be available to those of ordinary skill in the art, such as a hydraulic press. The pressing may take place at room temperature. In other embodiments, a hot press method may be used. In these embodiments, the separated bamboo strips 28 may be loaded into a mold, such as a panel-shaped mold. Subsequently, pressure and heat may be applied to the mold. While under pressure, one or more pins and/or clamps may be applied to the mold, such that pressure in the mold may be maintained after the press is removed.

Step K may be drying, as shown in FIG. 1. After the pressing step is complete, the block of bamboo material may remain in the mold for an amount of time, and may also be subject to heat. During this step, the separated bamboo strips 28 may be compressed, compacted, and/or solidified to form a block of bamboo material. A variety of temperatures and/or times may be used according to factors including but not limited to mold size, ambient temperature, and ambient humidity. In some embodiments, the block of bamboo material may be heated to a temperature of about 75° C. to about 175° C. In other embodiments, the block of bamboo material may be heated to a temperature of about 100° C. to about 150° C. Although not to be bound by any theory, it is believed that the heat may promote bonding of the glue with the bamboo and/or the transformation of the glue from a liquid state to a solid state. In some embodiments, a block of bamboo material may be heated for approximately 6 hours to approximately 72 hours. In an embodiment, a block of bamboo material may be heated for about 12 hours to about 48 hours.

After drying, the block may be removed from the mold and skinned, as shown in Step L of FIG. 1. In the skinning step, the outer layer of the block may be removed. The outer layer may be removed by a variety of methods as known to those of ordinary skill in the art, such as by hand or by machine. In some embodiments, the skinning may be done by hand using a tool with a sharp blade, such as a knife or a machete. In some embodiments, the outer layer of the block may be removed to the extent which is needed for the block to fit in a cutting machine. In other embodiments, the ends of the block may be cut to create a substantially planar, uniform face. In still other embodiments, the outer layer of the block may be a different color compared to the interior of the block. In these embodiments, the outer layer of the block may be removed to the extent needed to result in a block of substantially uniform color.

Subsequently, the block of bamboo material may remain at approximately room temperature for an amount of time for stabilization, as shown in Step M of FIG. 1. The amount of time may vary according to factors including but not limited to mold size, ambient temperature, and ambient humidity. In some embodiments, the block of bamboo material may remain in the mold at approximately room temperature for about 2 days to about 1 week. In other embodiments, the block of bamboo material may remain in the mold at approximately room temperature for about 3 days to about 2 weeks. Although not to be bound by any theory, it is believed that this step allows for the dissipation of residual heat and/or kinetic energy generated from the pressing and/or drying steps.

Once the stabilization step is complete, additional optional steps may follow. In some embodiments, the manufactured bamboo product may be cut into boards or planks for flooring. In an embodiment, one block of manufactured bamboo product may be sawn into about 5 to about 7 planks. The manufactured bamboo product may also undergo a fourth drying step. The manufactured bamboo product may be dried at a temperature and for a length of time as needed. In some embodiments, the water content of the manufactured bamboo product after drying can be from about 5 wt % to about 15 wt %. In other embodiments, the water content of the manufactured bamboo product after drying can be from about 6 wt % to about 12 wt %.

After drying, the planks of manufactured bamboo product may be subject to a finishing process. For example, the planks may be sanded, and the edges of the planks may be milled. The manufactured bamboo product may also be subject to further treatments to increase its durability and aesthetic value. Such treatments may include, but are not limited to, addition of water-repellants, preservatives, UV stabilizers, laminates, colorants, and stains.

Manufactured bamboo products made by the methods described herein may have a variety of uses. A block of manufactured bamboo product as described herein may be cut into boards, for use as a wood substitute. These manufactured bamboo products may be particularly suitable for ornamental or aesthetic purposes where the grain is displayed, as in a wood flooring substitute.

### EXAMPLES

### Example 1

Five-year old bamboo culm is cut into 1,500 mm-long sections. The inner and outer nodes, the outer green layer, and the innermost layer are removed. The resulting bamboo sections are sliced into elongated bamboo strips 10 mm wide and 3 mm thick. Each elongated bamboo strip is fed through the rolling machine to form a separated bamboo strip with continuously-connected longitudinal raised-notch staggered bands. The width of each band is 1.5 mm, i.e. the separated bamboo strip is 10 mm wide, 3 mm thick and 1,500 mm long with 6 raised-notch staggered bands having a similar thread and similar structure throughout.

### Example 2

Four-year old bamboo culm is cut into 2,000 mm-long sections. The inner and outer nodes are removed, but the outer green layer and the innermost layer remain. The bamboo sections are sliced into elongated bamboo strips of regular 4 mm thickness and 30 mm width. Each strip is fed through the rolling machine to form a separated bamboo strip with 7 continuously-connected longitudinal raised-notch staggered bands, each 4 mm wide, with a shape similar to the bands formed on the separated bamboo strip in Example 1.

### Example 3

Six-year old bamboo is cut into 2,500 mm-long sections. The inner and outer nodes, the outer green layer, and the innermost layer are removed. The resulting bamboo sections are sliced into elongated bamboo strips 20 mm wide and 3 mm thick. Each elongated bamboo strip is fed through the rolling machine to form a separated bamboo strip with 6 continuously-connected longitudinal raised-notch staggered bands. Each band is approximately 3 mm wide and has a shape similar to the bands formed on the separated bamboo strip in Example 1.

The various methods described above provide a number of ways to carry out some preferred embodiments of the invention. Of course, it is to be understood that not necessarily all objectives or advantages described may be achieved in accordance with any particular embodiment described herein. Thus, for example, those skilled in the art will recognize that the compositions may be made and the methods may be performed in a manner that achieves or optimizes one advantage or group of advantages as taught herein without necessarily achieving other objectives or advantages as may be taught or suggested herein.

Furthermore, the skilled artisan will recognize the interchangeability of various features from different embodiments. Similarly, the various components, features and steps discussed above, as well as other known equivalents for each such component, feature or step, can be mixed and matched by one of ordinary skill in this art to make compounds and perform methods in accordance with principles described herein.

Although the invention has been disclosed in the context of some embodiments and examples, it will be understood by those skilled in the art that the invention extends beyond these specifically disclosed embodiments to other alternative embodiments and/or uses and obvious modifications and equivalents thereof Accordingly, the invention is not intended to be limited by the specific disclosures of preferred embodiments herein.

What is claimed is:

1. A method of preparing bamboo for use in a manufactured bamboo product, comprising:
providing a plurality of elongated bamboo strips; and
separating each elongated bamboo strip along its length into a plurality of bamboo lengthwise segments that remain attached.

2. The method of claim 1, wherein each separated bamboo strip comprises a plurality of continuously-connected bands.

3. The method of claim 1, wherein each separated bamboo strip comprises a plurality of continuously-connected longitudinal raised-notch staggered bands.

4. The method of claim 1, wherein the manufactured bamboo product comprises a bamboo board.

5. The method of claim 1, wherein the manufactured bamboo product comprises bamboo flooring.

6. A method of preparing bamboo for use in a manufactured bamboo product, comprising:
providing a plurality of elongated bamboo strips; and
separating each elongated bamboo strip along its length into a plurality of bamboo lengthwise segments comprising a plurality of continuously-connected longitudinal raised-notch staggered bands.

7. A method of making a manufactured bamboo product, comprising:
providing a plurality of elongated bamboo strips;
separating each elongated bamboo strip along its length into a plurality of bamboo lengthwise segments that remain attached;
applying glue to each separated bamboo strip;
loading the separated bamboo strips into a mold; and
applying pressure to the separated bamboo strips in the mold to produce a manufactured bamboo product.

8. The method of claim 7, wherein each separated bamboo strip comprises a plurality of continuously-connected bands.

9. The method of claim 7, wherein each separated bamboo strip comprises a plurality of continuously-connected longitudinal raised-notch staggered bands.

10. The method of claim 7, wherein each separated bamboo strip is carbonized prior to the glue application step.

11. The method of claim 7, wherein each separated bamboo strip is at least partially dried before the application of glue.

12. The method of claim 7, wherein the glue comprises phenol, formaldehyde, water, and sodium hydroxide.

13. The method of claim 7, wherein the glue is applied by dip-coating.

14. The method of claim 7, wherein each separated bamboo strip is at least partially dried after the application of glue and before the loading of the sheets into the mold.

15. The method of claim 6, wherein the pressure applied to the separated bamboo strips is from about 10 MPa to about 100 MPa.

16. The method of claim 7, wherein the manufactured bamboo product comprises a bamboo board.

17. The method of claim 7, wherein the manufactured bamboo product comprises bamboo flooring.

18. The method of claim 7, wherein the plurality of bamboo strips is made by a process comprising:
providing a section of a bamboo culm with one or more interior or exterior nodes, said section having a length of at least 1000 mm along the natural grain thereof;
removing the one or more interior or exterior nodes; and
cutting the bamboo section generally lengthwise along the grain thereof into a plurality of bamboo strips.

19. The method of claim 18, further comprising removing at least some of the sugar from the plurality of bamboo strips.

20. The method of claim 18, further comprising drying the plurality of bamboo strips to a final water content of about 5 wt % to about 15 wt %.

21. The method of claim 7, wherein the plurality of bamboo strips comprises one or more of an exterior green surface and an innermost surface of a bamboo culm.

22. The method of claim 7, further comprising heating the separated bamboo strips in the mold at a temperature of about 75° C. to about 175° C.

23. The method of claim 22, further comprising:
removing the separated bamboo strips from the mold to yield a bamboo block;
removing at least a portion of an outer layer from the bamboo block;
allowing the bamboo block to sit substantially at room temperature;
cutting the bamboo block into boards; and
at least partially drying the bamboo boards.

24. The method of claim 23, further comprising the application of one or more additional treatments selected from the group consisting of a water-repellant, preservative, UV stabilizer, laminate colorant, and stain.

25. A manufactured bamboo product made by the process of claim 7.

26. A method of preparing bamboo for use in a manufactured bamboo product, comprising:
providing a plurality of elongated bamboo strips; and
applying pressure to each elongated bamboo strip using a rolling machine that comprises upper and lower ridged rollers, each of said rollers comprising an outer circumference traversed by a series of alternating ridges and grooves;
wherein the application of pressure separates each elongated bamboo strip along its length into a plurality of bamboo lengthwise segments that remain attached.

27. The method of claim 26, wherein each elongated bamboo strip has a thickness in the range of about 2 mm to about 5 mm.

28. The method of claim 26, wherein each of the upper and lower ridged rollers has a diameter in the range of about 5 cm to about 15 cm.

29. The method of claim 26, wherein the ridges of the upper roller and the grooves of the lower roller are staggered.

30. The method of claim 26, wherein each upper and lower ridged roller has about five to about ten ridges.

31. The method of claim 26, wherein each ridge and each groove has a width in the range of about 1 mm to about 5 mm.

32. The method of claim 31, wherein the width of each groove is wider than the width of each ridge, resulting in a horizontal gap.

33. The method of claim 32, wherein the horizontal gap has a width in the range of about 0.1 mm to about 0.8 mm.

34. The method of claim 26, further comprising a vertical gap between the upper and lower ridged rollers, said vertical gap having a distance in the range of about 1 mm to about 5 mm.

35. The method of claim 26, wherein each separated bamboo strip comprises a plurality of continuously-connected bands.

36. The method of claim 35, wherein each separated bamboo strip comprises a plurality of continuously-connected longitudinal raised-notch staggered bands.

37. The method of claim 36, wherein each longitudinal raised-notch staggered band has a width in the range of about 1 mm to about 5 mm.

38. The method of claim 36, wherein the separated bamboo strip has about five to about ten longitudinal raised-notch staggered bands.

39. The method of claim 36, wherein the separated bamboo strip maintains approximately the shape of the elongated bamboo strip.

40. A method of making a manufactured bamboo product, comprising:
providing a plurality of elongated bamboo strips;
applying pressure to each elongated bamboo strip using a rolling machine that comprises upper and lower ridged rollers, each of said rollers comprising an outer circumference traversed by a series of alternating ridges and grooves, wherein the application of pressure separates each elongated bamboo strip along its length into a plurality of bamboo lengthwise segments that remain attached;
applying glue to each separated bamboo strip;
loading the separated bamboo strips into a mold; and
applying pressure to the separated bamboo strips in the mold to produce a manufactured bamboo product.

41. The method of claim 40, wherein each elongated bamboo strip has a thickness in the range of about 2 mm to about 5 mm.

42. The method of claim 40, wherein each separated bamboo strip comprises a plurality of continuously-connected bands.

43. The method of claim 40, wherein each separated bamboo strip comprises a plurality of continuously-connected longitudinal raised-notch staggered bands.

44. The method of claim 40, wherein each separated bamboo strip is carbonized prior to the glue application step.

45. The method of claim 40, wherein each separated bamboo strip is at least partially dried before the application of glue.

46. The method of claim 40, wherein the glue comprises phenol, formaldehyde, water, and sodium hydroxide.

47. The method of claim 40, wherein the glue is applied by dip-coating.

48. The method of claim 40, wherein each separated bamboo strip is at least partially dried after the application of glue and before the loading of the sheets into the mold.

49. The method of claim 40, wherein the pressure applied to the separated bamboo strips is from about 10 MPa to about 100 MPa.

50. The method of claim 40, wherein the manufactured bamboo product comprises a bamboo board.

51. The method of claim 40, wherein the manufactured bamboo product comprises bamboo flooring.

52. The method of claim 40, wherein the plurality of bamboo strips is made by a process comprising:
providing a section of a bamboo culm with one or more interior or exterior nodes, said section having a length of at least 1000 mm along the natural grain thereof;
removing the one or more interior or exterior nodes; and
cutting the bamboo section generally lengthwise along the grain thereof into a plurality of bamboo strips.

53. The method of claim 52, further comprising removing at least some of the sugar from the plurality of bamboo strips.

54. The method of claim 53, further comprising drying the plurality of bamboo strips to a final water content of about 5 wt % to about 15 wt %.

55. The method of claim 40, wherein the plurality of bamboo strips comprises one or more of an exterior green surface and an innermost surface of a bamboo culm.

56. The method of claim 40, further comprising heating the separated bamboo strips in the mold at a temperature of about 75° C. to about 175° C.

57. The method of claim 56, further comprising:
removing the separated bamboo strips from the mold to yield a bamboo block;
removing at least a portion of an outer layer from the bamboo block;
allowing the bamboo block to sit substantially at room temperature;
cutting the bamboo block into boards; and
at least partially drying the bamboo boards.

58. The method of claim 57, further comprising the application of one or more additional treatments selected from the group consisting of a water-repellant, preservative, UV stabilizer, laminate colorant, and stain.

59. A manufactured bamboo product made by the process of claim 40.
